(19) United States
(12) Patent Application Publication
(10) Pub. No.: US 2016/0023389 A1
(43) Pub. Date: Jan. 28, 2016

(54) METAL/PLASTIC HYBRID STRUCTURAL PARTS

(71) Applicants: REHAU AG & CO., Rehau (DE); HUNTSMAN ADVANCED MATERIALS (SWITZERLAND) GMBH, Basel (CH)

(72) Inventors: Dragan Griebel, Rehau (DE); Marcel Sommer, Basel (CH)

(21) Appl. No.: 14/876,939

(22) Filed: Oct. 7, 2015

Related U.S. Application Data
(63) Continuation of application No. 12/302,544, filed on Mar. 3, 2009.

(30) Foreign Application Priority Data
May 31, 2006 (DE) 10 2006 025 745.6
Oct. 25, 2006 (DE) 10 2006 050 144.6

(51) Int. Cl. B29C 45/14; B32B 27/08; B29C 37/00; B32B 15/092

(52) U.S. Cl. CPC B29C 45/14311; B32B 15/092; B32B 27/08; B29C 37/0025; B29K 2077/00

(57) ABSTRACT

The invention relates to a structural part that has a metal component, a plastic component and a bonding agent system interconnecting the metal component and the plastic component. The invention is characterized in that the bonding agent system consists of a plastic bonding agent or of a plastic bonding agent combined with a primer, the plastic bonding agent being a polyester, a polyurethane or an epoxide that is modified with a diene and/or a polyene. The invention also relates to a method for producing said structural part.

The present invention relates to structural parts with a metal component and a plastic component which are interconnected by means of a bonding agent.

Metal/plastic composite parts are to combine the respective positive properties of the components metal and plastics in one part. Parts of two different components, metal and plastics, are here referred to as “hybrid” parts. The properties and working behavior of metals and plastics, however, greatly vary and can therefore not be easily interconnected such that a permanent and loadable connection is obtained.

From DE 38 39 855 C2, a composite part is known in which reinforcing ribs of plastics are injected to a basic body of metal. The metal basic body comprises openings through which the plastics is injected. This means that this is a positive connection where the plastics quasi gets caught in the metal. It is alternatively known to achieve a positive connection via a corresponding lock-beading of the metal component. Such positive connections are not satisfactory for loaded parts with respect to their bond strength. Moreover, the parts are corrodible as moisture can penetrate between the metal component and the plastic component due to capillary action.

It is also known to connect a metal component coated with adhesive lacquer with a plastic component in a continuous process by coextrusion. The metal component, which in this case is present as a foil, is preheated, so that the bonding agent layer is activated during extrusion and a connection of the metal component with the applied plastic component is created. An activation of the bonding agent requires exceeding a determined temperature depending on the respective bonding agent employed. If this temperature is not achieved, this results in an insufficient connection between the two components of the composite part. As metals are good heat conductors, it is often difficult to achieve a sufficient temperature, in particular in case of large and bulky parts.

According to WO 2005/032793, this method is further developed in that a bonding agent that can be activated by means of subsequent heating is used, i.e. first a composite part is manufactured by injecting a plastic component onto a metal component, and the metal component is subsequently heated again to activate the bonding agent layer. By this method, a material connection between metal component and plastic component is obtained.

The method according to WO 2005/032793 results in a stability of the connection between metal and plastics which is absolutely sufficient for components that are not subjected to heavy mechanical loads, for example for pure decoration parts. The composite parts can be possibly even employed for parts that are subjected to certain mechanical loads, but of which a possible failure does not have any severe consequences.

In case of structural parts, in particular supporting parts, movable parts and/or security-relevant parts of a vehicle, an equipment or any other device, however, demands on strength and reliability of the connection of metal and plastics have to be made which cannot be met by the prior art.

It is therefore the object of the present invention to provide structural parts with a metal component and a plastic component which are permanently and loadably connected to each other.

It is in particular the object of the present invention to provide structural parts that are statically and dynamically loadable.

It is furthermore the object of the present invention to provide structural parts that comprise high flexural strength and stiffness against torsion.

It is moreover the object of the present invention to provide structural parts that can be employed in areas that are subject to corrosion.

The present invention relates to a structural part, comprising a metal component, a plastic component and a bonding agent system connecting the metal component and the plastic component, wherein the bonding agent system consists of a plastic bonding agent or of a plastic bonding agent in combination with a primer, and wherein the plastic bonding agent is a polyester, a polyurethane or an epoxide modified with a diene and/or a polyene.

The structural part according to the invention can be obtained according to a method comprising the following steps:
a) providing a metal component, wherein the metal component is coated with a precured, i.e. pre-crosslinked bonding agent system on one side or on all sides,
b) introducing the metal component coated with the precured bonding agent system into an injection mold, such that the precured bonding agent layer faces a free volume in the mold,
c) injection molding a plastic component onto the metal component, wherein the bonding agent system further cures, and
   wherein a bonding agent system consisting of a plastic bonding agent or of a plastic bonding agent in combination with a primer is used as bonding agent system, and the plastic bonding agent is a polyester, a polyurethane or an epoxide modified with a diene and/or a polyene.

The term “one” is to be understood in the present description and the claims as “at least one”.

The crucial point of the present invention is the bonding agent system. It is a heat-reactive (crosslinkable) system curing in two steps, which can be optimally adjusted to the plastics to be injected thanks to its particular composition, in particular to the modification with dienes and/or polyenes. By this, hitherto unachieved bond strength is achieved by a material connection between metal and plastics.

As metal component, basically all metals can be used, in particular those metals common in the field of structural parts, such as steel with different strengths, high-grade steel, tin, light metals, such as aluminum and magnesium, etc., or a metal alloy, e.g. with carbon, chromium, nickel and molybdenum. The metal is preferably steel that is free from coatings or lubricants.

The metal component is typically employed in the form of sheet metal or sheet metal formed to shaped parts.

Preferred materials for the plastic component are selected depending on the intended application temperature range and depending on the mechanical demands Fiber reinforced plastic materials, e.g. glass-fiber reinforced or carbon-fiber reinforced plastic materials, guarantee particular high strength. Polymer materials with a low surface energy can also be used, such as PE, PP and PA.

As plastic materials, homopolymers, e.g. of PE, PP or PA, a polyolefin, a polyamine, a polystyrene, a polyethersulfone (PES), a polyethyleneimine (PEI), a polyetherketone (PEK), or a polyetheretherketone (PEEK) can be used.

The plastic material can be reinforced with fibers and/or fillers and/or further additives, such as dies, flame retardants or melt flow enhancers.

If the plastic material is reinforced with fibers, the fiber content can be up to 60 weight percent.

Typical plastic materials to be applied by injection molding are polypropylene (PP), for example PP LGF 30, polyamide (PA), for example PA 6 GF and PA 6.6 GF, polyamide-polyphenylene oxide blends (PA-PPO blends), polyamide-polystyrene (syndiotactic) blends (PA-sPS blends), polyamide-acrylonitrile-butadiene-styrene-copolymer blends (PA-ABS blends), polyphthalamide (PPA), polyphenylene sulfide (PPS), and polysulfone (PSU).

In a preferred embodiment, the plastic material to be applied by injection molding is PA 6 GF or PA 6.6 GF, where the glass fiber content is in each case 30 weight percent.

In the above designations, GF stands for glass fiber, LGF for long glass fiber, and the number behind LGF means the weight percentage of the long glass fiber in the plastics.

Long glass fibers are used due to their size aspect (ratio of length to height). They increase dimensional stability under heat and the impact resistance of plastics, e.g. of the polypropylene. Great demands can already be made on short glass fiber reinforced (GF) plastics as regards dimensional stability under heat and the degree of shrinkage; long glass fiber reinforced plastics can meet even greater thermal and mechanical demands. In case of PP LGF, strength and stiffness exceed the values of GF (short fiber)-filled polypropylene compounds by 30%, the impact value even by up to 300%.

For the temperature range of +100° C., i.e. for thermally only slightly loaded structural parts, for example PP LGF 30 can be used, i.e. polypropylene with a proportion of 30 weight percent of long glass fibers.

For the temperature range of −40° C. to +120° C. or +140° C., i.e. for thermally more loaded structural parts, depending on the mechanical demands, higher-quality plastics are required, such as polyamide, e.g. PA 6 GF or PA 6.6 GF. Polyamides (PA) of the amino acid type are formed from one unit by polycondensation or polymerisation (ε-lactam), and polyamides of the diamine-dicarboxylic acid type are formed from two units by polycondensation. The polyamides from non-branched aliphatic units are coded by the number of carbon atoms, i.e. PA 6 is constituted from aminohexane acid (or ε-caprolactam), and PA 6.6 is constituted from hexamethylene diamine and adipic acid.

As an alternative to PA 6 GF and PA 6.6 GF, PA-PPO blends and PA-sPS blends can be used, where PPO stands for polyphenylene oxide and sPS means syndiotactic polystyrene.

For the temperature range of −40° C. to more than +140° C., i.e. for thermally highly loaded structural parts, depending on the mechanical and chemical demands, high-performance construction plastics are required, e.g. PPA, PPS. PPA stands for polyphthalamide, and PPS stands for polyphenylene sulfide. As alternatives, in general partially aromatic polyamides and PSU can also be employed. PSU stands for polysulfone (poly[oxy-1,4-phenylene-sulfonyl-1,4-phenylene-oxy-(4,4′-isopropylidenediphenylene)]).

The structural parts according to the invention are particularly suited for body parts of vehicles due to their lightness, strength and safe connection. Inseparably connected vehicle body parts must meet the demands in the temperature range of −40° C. to +120° C. These components must pass the painting plants in vehicle manufacture without their function, geometry, surface, etc. being impaired. These involve the following conditions: in catalytic immersion coating typically 20 minutes at 200° C., for the filler application 30 minutes at 160° C., and for the covering lacquer application 30 minutes at 150° C. Correspondingly, as plastic material, e.g. polyamide, for example PA 6 GF, PA 6.6 GF, has to be employed.

Attachments that are separably connected to the basic body do not necessarily have to meet these demands in connection with the ability of being subjected to catalytic immersion coating. Such parts are typically only attached subsequently. For example PP LGF is suited as plastics for such attachments.

Moreover, the plastics have to meet the mechanical demands, essentially demands on torsion and bending, as well as possibly other demands, e.g. chemical resistance, electrical conductivity, odorlessness, etc.

The bonding agent system is a two-stage bonding agent system, i.e. a bonding agent system that is completely crosslinked in two subsequent steps. Crosslinking is performed by thermal activation. The bonding agent system consists of the “actual” bonding agent, a plastic bonding agent which can be used alone or in combination with a primer which is used to improve the activation of the metal surface. The bonding agent system is applied onto the sheet material or the metal component and partly crosslinked in a first step, so that a dry surface is formed which is sufficiently resistant against handling damages. During or after the application of plastics by injection molding, the bonding agent system is completely crosslinked, such that it obtains its final properties. The complete crosslinking of the bonding agent system can be performed, for example, in a subsequent curing step or during the passage through catalytic immersion coating. The catalytic immersion coating which is carried out at 165 to 215° C., preferably at 190 to 200° C., increases strength and glass transition temperature Tg of the bonding agent system.

The bonding agent system has to materially connect on the one hand with the metal material, and on the other hand with the plastic material. Correspondingly, its material composition is selected depending on the metal component and the plastic component of the structural part, in particular depending on the plastic component.

If the bonding agent system comprises a primer, conventional primers as they are known in the art are employed. The primer comprises metallophilic groups that take care of a material connection to the metal, as well as organic groups that are able to bind to a plastics or a material on the basis of plastics, such as the bonding agent matrix. The primers are organic compounds which possess hydroxy, thiol, amino or carboxy groups for the connection to the metal. Moreover, metal salts and, more preferred, metallo-organic compounds, such as functionalized iron cyclopentadienyles, can be employed. The functional group binds to the metal, the organic molecular part binds to the plastic bonding agent.

Alternatively or in addition to the mentioned primers, organo-functionalized alkoxy silanes, such as 3-(trimethoxysilyl)-1-propanamine, 3-(trimethoxysilyl)-propylmethacrylate, N-1-[3-(trimethoxysilyl)propyl]-1,2-ethanediamines, 3-(triethoxysilyl)-propanenitriles, 3-glycidyloxypropyl-trimethoxysilane etc., can be used. They are applied onto the metal surface in a diluted form, e.g. as 1 to 10% alcoholic or aqueous solution, and are in particular characterized in that they take care of a particular good connection between the components. The alkoxy functionality of the silane binds to the metal surface, and the additional functionality at the organic group binds to the matrix of the plastic bonding agent.

Moreover, mixtures of the silanes with prepolymers, for example of carbamates, can be employed. Suited mixing ratios (weight ratios) of silane:prepolymer are from 1:50 to 1:1.

The primer can, only by way of example but not restrictively, have the following composition: 3 to 8 weight percent of 3-glycidoxypropyl-methyldimethoxysilane or 1-[3-(trimethoxysilyl)propyl]urethane or 3-(trimethoxysilyl)propyl-methacrylate plus 2 to 5 weight percent of N-(2-aminoethyl)-3-(trimethoxysilyl)propylamine or 3-(trimethoxysilyl)propylamine or 3-(trimethoxysilyl)-1-propanethiol in an alcohol or in a mixture of alcohols, where ethanol, methanol and isopropylalcohol are preferred. A 5 to 15 weight percent solution of N-[3-(trimethoxysilyl)propyl]-N′-(4-vinylbenzyl)ethylenediamine hydrochloride, e.g. in methanol, is also suited.

The “actual” bonding agent, the plastic bonding agent, is applied onto the primer and on the one hand binds to the primer and on the other hand takes care of the material connection to the plastics. Alternatively, primer and plastic bonding agent can also be mixed. The “actual” bonding agent is, after curing, a plastic material itself. It typically also comprises metallophilic groups or contains components with metallophilic groups, so that a primer can be dispensed with and the material connection to the metal can also be effected by the plastic bonding agent. The plastic bonding agent is then directly applied onto the metal.

The plastic bonding agent which takes care of the material connection to the plastics and binds to the primer and/or the metal surface, is preferably a polyester or a polyurethane or an epoxide, particularly preferred an epoxy resin based on bisphenol A and/or bisphenol B and/or bisphenol C and/or bisphenol F, and/or a novolac system.

Bisphenol A is 2,2-bis-(4-hydroxyphenyl)-propane, bisphenol B is 2,2-bis-(4-hydroxyphenyl)-butane, bisphenol C is 1,1-bis-(4-hydroxyphenyl)-cyclohexane, and bisphenol F is 2,2-methylenediphenol. Bisphenol A and bisphenol B are particularly preferred. If they are employed as a mixture, the weight ratio is preferably in the range of 1:1 to 1:10 of bisphenol A:bisphenol B.

The adaptation of the bonding agent system to the respective plastics to be connected is essentially performed by modification with dienes, in particular 1,3-dienes, or by modification with polyenes, such as natural rubber or synthetic rubber, where the dienes and/or polyenes can be covalently bound to the resin (polymerized into the bonding agent matrix) and/or physically incorporated into the bonding agent matrix (additivated). The diene proportion and/or the polyene proportion in the bonding agent system is preferably 1 to 30 weight percent, particularly preferred 3 to 10 weight percent.

Elastomer-modified expoxy adhesive bonding agents are, for example, obtained by polymerizing in 1,3-butadiene (covalent bond) or by addition of rubber (physical incorporation, additivation).

The plastic bonding agent is preferably the sole bonding agent. In expoxy systems, the epoxy group can be, for example, used for the metal activation and material connection to the metal.

A further adaptation of the bonding agent system to the respective plastics to be connected is possible by the addition of alkyl- and/or aryl-modified silanes of the general formula HO—Si (R)(R′)(R″), wherein the groups R, R′ and R″ can be the same or partially or all differently modified with alkyl and/or aryl groups, wherein the alkyl and/or aryl groups bear functional groups, such as COOH, OH, NH₂. The silanes provide the crosslinkage (by the functionality to the organic groups) and the connection to the metal (by the hydroxyl group at the silicon). However, the silanes are not absolutely necessary, as the connection to the metal can also be effected via functional groups at the plastic bonding agent.

By the material connection, no capillary action occurs any more (i.e. creeping of moisture between the plastic material and the metal material) due to the all-over gluing between the plastic material and the metal material by means of the bonding agent system. This permits molding around open, i.e. not protected interfaces and other unprotected metal surfaces with the plastic material. As long as an all-over gluing is provided on both sides, no moisture can reach the unprotected sides, except for by diffusion, so that sufficient corrosion resistance is realized. The bonding agent itself is of course corrosion and hydrolysis resistant.

The bonding agent can simultaneously provide corrosion protection, in particular if a plastic-based system is used, for example an epoxy system, a polyester or a polyurethane system. With such a selection of the bonding agent, the cured bonding agent forms an anticorrosive layer for the metal material in the finished component in those areas where it is not covered by plastic material. It is important to apply the bonding agent system as dense layer.

Where necessary, it is required for the bonding agent to be CIC-capable (CIC—catalytic immersion coating). For this, in particular sufficient thermal stability and electrical conductivity are required.

An electrically conductive bonding agent is obtained by adding electrically conductive ingredients. Suited electrically conductive ingredients are, on an organic basis, for example carbon black and graphite, and on an inorganic basis, metal powder, such as zinc dust.

In some applications, the bonding agent must be weldable, i.e. it has to be possible to weld the metal parts coated with the bonding agent.

Essential prerequisites for this are on the one hand electrical conductivity and thermal stability. Moreover, it should be incombustible. Thermal stability is preferably achieved by using highly crosslinked epoxy systems on the basis of bisphenol A and/or bisphenol B.

Incombustibility is achieved by halogenated bisphenols. For example, the bonding agent can be constituted on the basis of 2,2-bis-(3,5-dibromo-4-hydroxyphenyl)-propane and/or tetrabromobisphenol A, or contain these bisphenols additionally. Alternatively or additionally, conventional flame retardants (halogenated or halogen-free) can be added to the bonding agent.

In particular during the application of the bonding agent in a coil coating method, sufficient elasticity or formability of the bonding agent after the first partial crosslinking step is required, so that the bonding agent all-over adheres to the metal material after forming, and this even in areas of extreme bending. The elasticity of the bonding agent can be increased, for example by bonding elastomer (1,3-butadiene) to the bonding agent or by additivating the bonding agent with rubber.

To improve the material connection to the metal, corrosion protection, electrical conductivity, thermal stability, incombustibility and elasticity, the above mentioned materials can be added individually or in combination, depending on the desired property.

Dies can be added as further additives.

In one preferred embodiment of the invention, epoxy resins, toughening agents, and amines as hardener, preferably fast-reacting amines, react in a first curing step, and permit an adjustment of the adhesive strength of the film (B stage).

Preferably, the final curing takes place at an elevated temperature in a second curing step. It is preferred to use a latent hardener for this step. The curing speed of this latent hardener can optionally be adjusted with accelerators.

Below, preferred embodiments of the epoxy resin, the toughening agent, the hardener, the latent hardener and further optional ingredients of the bonding agent are represented.

### Epoxy Resin

The epoxy resin is contained in the bonding agent preferably in a concentration of 20 to 80 weight percent, more preferably in a concentration of 50 to 70 weight percent.

As a matter of principle, all epoxy resins common in epoxy resin technology can be used in the bonding agent according to the invention. It is also possible to use a mixture of epoxy resins.

### Examples of Epoxy Resin are:

I) Polyglycidyl and poly(ss-methylglycidyl)ester, available by reacting a compound with at least two carboxyl groups in the molecule, epichlorohydrin and ss-methylepichlorohydrin. The reaction is expediently carried out in the presence of bases.

Aliphatic polycarboxylic acids can be used as the compound with at least two carboxyl groups in the molecule. Examples of such polycarboxylic acids are oxalic acid, succinic acid, glutaric acid, adipic acid, pimelic acid, suberic acid, azelaic acid or dimerized or trimerized linoleic acid.

However, cycloaliphatic polycarboxylic acids, such as e.g. tetrahydrophthalic acid, 4-methyltetrahydrophthalic acid, hexahydrophthalic acid or 4-methylhexahydrophthalic acid, can be used.

Furthermore, aromatic polycarboxylic acids, such as e.g. phthalic acid, isophthalic acid or terephtalic acid can be used.

II) Polyglycidyl or poly(P-methylglycidyl)ether, available by reacting a compound with at least two free alcoholic hydroxyl groups and/or phenolic hydroxyl groups with epichlorohydrin or p-methylepichlorohydrin under alkaline conditions or in the presence of an acidic catalyst with subsequent treatment with alkaline.

The glycidyl ethers of this type are derived e.g. from acyclic alcohols, e.g. from ethylene glycol, diethylene glycol or higher poly(oxyethylene)glycols, propane-1,2-diol or poly(oxypropylene)glycols, propane-1,3-diol, butane-1,4-diol, poly(oxytetramethylen)glycols, pentane-1,5-diol, hexane-1,6-diol, hexane-2,4,6-triol, glycerol, 1,1,1-trimethylolpropane, pentaerythritol or sorbitol and from polyepichlorohydrins.

Further glycidyl ethers of this type are derived from cycloaliphatic alcohols, such as 1,4-cyclohexanedimethanol, bis(4-hydroxycyclohexyl)methane or 2,2-bis(4-hydroxycyclohexyl)propane or from alcohols containing aromatic groups and/or further functional groups, such as N,N-bis(2-hydroxyethyl)aniline or p,p′-bis(2-hydroxyethylamino)diphenylmethane.

The glycidyl ethers can also be based on mononuclear phenols, such as resorcinol or hydroquinone, or on polynuclear phenols, such as bis(4-hydroxyphenyl)methane, 4,4′-dihydroxybiphenyl, bis(4-hydroxyphenyl)sulfone, 1,1,2,2-tetrakis(4-hydroxyphenyl)ethane, 2,2-bis(4-hydroxyphenyl)propane or 2,2-bis(3,5-dibromo-4-hydroxyphenyl)propane.

Further suited hydroxy compounds for the manufacture of glycidyl ethers are novolacs, available by condensation of aldehydes, such as formaldehyde, acetaldehyde, chloral or furfuraldehyde, with phenols or bisphenols, unsubstituted or substituted by chlorine atoms or groups such as phenol, 4-chlorophenol, 2-methylphenyl or 4-tert-butylphenol.

III) Poly(N-glycidyl) compounds, available by dehydrochlorination of the reaction products of epichlorohydrin with amines, which contain at least two amino hydrogen atoms. These amines are e.g. aniline, N-butylamine, bis(4-aminophenyl)methane, m-xylylenediamine or bis(4-methylaminophenyl)methane.

The poly(N-glycidyl) compounds also contain triglycidylisocyanurate, N,N′-diglycidyl derivatives of cycloalkylene ureas, such as ethylene urea or 1,3-propylene urea, and diglycidyl derivatives of hydantoins, such as 5,5-dimethylhydantoin.

IV) Poly(S-glycidyl) compounds, e.g. di-S-glycidyl derivatives, derived from dithiols, such as e.g. ethane-1,2-dithiol or bis(4-mercaptomethylphenyl)ether.

V) Cycloaliphatic epoxy resins, such as e.g. bis(2,3-epoxycyclopentyl)ether, 2-epoxycyclopentylglycidylether, 1,2-bis(2,3-epoxycyclopentyloxy)ethane or 3,4-epoxycyclohexylmethyl-3′,4′-epoxycyclohexanecarboxylate.

However, it is also possible to use epoxy resins in which the 1,2-epoxy groups are bound to different heteroatoms or functional groups; these compounds include e.g. the N,N,O-triglycidyl derivatives of 4-aminophenol, the glycidylether-glycidylesters of salicylic acid, N-glycidyl-N′-(2-glycidyloxypropyl)-5,5-dimethylhydantoin or 2-glycidyloxy-1,3-bis(5,5-dimethyl-1-glycidylhydantoin-3-yl)propane.

Bisphenol-diglycidyl ether or an epoxy novolac are preferably used.

Bisphenol A-diglycidyl ether or epoxy cresol novolacs are particularly preferred.

### Toughening Agents (Impact Strength Modifiers)

The toughening agent is as described in the following patents EP0308664, EP0338985, EP0353190, EP0358603, EP0365479 or EP0381625.

Preferably, a diene copolymer and/or a phenol-terminated polyurethane and/or polyurea or a combination of the same can be contained as toughening agent. In another preferred embodiment, an amino-terminated or a carboxyl-terminated butadiene-acrylnitrile can be contained as toughening agents.

### Hardener

The hardener is contained in the bonding agent preferably in a concentration of 1 to 15 weight percent, more preferably in a concentration of 2 to 4 weight percent.

The hardeners for epoxy resins which are additionally used corresponding to the present invention are preferably fast-reacting amines, such as aliphatic, cycloaliphatic, araliphatic or aromatic amines, optionally aminoamides containing imidazoline groups and their adducts with glycidyl compounds which on average contain more than two reactive, active hydrogen bonds to amino nitrogen atoms per molecule. These compounds are part of the prior art and are described inter alia in Lee & Neville, “Handbook of Epoxy Resins”, MC Graw Hill Book Company, 1987, Chapters 6-1 to 10-19.

Particularly preferred are polyetheramines.

### Latent Hardeners

The latent hardener is contained in the bonding agent preferably in a concentration of 1 to 15 weight percent, more preferably in a concentration of 5 to 11 weight percent.

Basically, each compound known for this purpose and corresponding to the specifications of the compound can be used as latent hardener, i.e. each compound which is inert with respect to the epoxy resin below the defined restrictive temperature of 70° C. (measured by means of DSC at a heating rate of 10° C./min), which, however, reacts fast while crosslinking the resin as soon as this restrictive temperature is exceeded. The restrictive temperature of the latent hardener used corresponding to this invention is preferably at least 85° C., in particular at least 100° C. Such compounds are known and commercially available.

Examples of suited latent hardeners are dicyandiamide, cyanoguanidines, such as the compounds described in U.S. Pat. No. 4,859,761 or EP-A-306451, aromatic amines, such as 4,4′- or 3,3′-diaminodiphenylsulphones, or guanidines, such as 1-O-tolylbiguanide, or modified polyamines, such as Ancamine@ 2014 S (Anchor Chemical UK Limited, Manchester).

Other suited latent hardeners are N-acylimidazoles, such as 1-(2′,4′,6′-trimethylbenzoyl)-2-phenylimidazol or 1-benzoyl-2-isopropylimidazol.

Such compounds are described, for example, in U.S. Pat. No. 4,436,892, U.S. Pat. No. 4,587,311 or in the Japanese patent 743,212.

Other suited hardeners are metallic salt complexes of imidazoles, such as described in U.S. Pat. No. 3,678,007 or U.S. Pat. No. 3,677,978, carboxylic acid hydrazides, such as adipic acid dihydrazide, isophthalic acid hydrazide or anthranilic acid hydrazide, triazine derivatives, such as 2-phenyl-4,6-diamino-s-triazine(benzoguanamine) or 2-lauryl-4,6-diamino-s-triazine(lauroguanamine), and melamine and its derivatives. The latter compounds are described e.g. in U.S. Pat. No. 3,030,247.

Other suited latent hardeners are cyanoacetyl compounds, as described e.g. in U.S. Pat. No. 4,283,520, such as neopentylglycolbiscyanoacetate, N-isobutylcyanoacetamides, 1,6-hexanemethylenebiscyanoacetate or 1,4-cyclohexanedimethanolbiscyanoacetate.

Other suited latent hardeners are N-cyanoacylamide compounds, such as N,N′-dicyanadipamide. Such compounds are described, for example, in U.S. Pat. No. 4,529,821, U.S. Pat. No. 4,550,203 and U.S. Pat. No. 4,618,712.

Further suited latent hardeners are the acylthiopropylphenols and urea derivatives disclosed in U.S. Pat. No. 3,386,955, such as toluene-2,4-bis(N,N-dimethylcarbamide).

Further suited latent hardeners are also imidazoles, such as imidazole, 2-ethylimidazole, 2-phenylimidazole, 1-methylimidazole, 1-cyanoethyl-2-ethyl-4-methylimidazole or 2-ethyl-4-methylimidazole.

Further suited latent hardeners are also tertiary amines, such as benzyldimethylamine or 2,4,6-tris(dimethylaminomethyl)phenol.

Preferred latent hardeners are diaminodiphenylsulphone, dicyandiamide, phenylimidazole and 2,4,6-tris(dimethylaminomethyl)phenol.

Particularly preferred is dicyandiamide.

### Accelerators for Latent Hardeners

The accelerator is optionally used and is contained in the bonding agent in a concentration of 0 to 8 weight percent, more preferably in a concentration of 2 to 4 weight percent.

Expediently, the mixtures according to the invention can also contain accelerators for the crosslinking reaction with the latent hardener. Suited accelerators are e.g. urea derivatives, such as N,N-dimethyl-N′-(3-chloro-4-methylphenyl) urea (chlorotolurone), N,N-dimethyl-N′-(4-chlorophenyl) urea (monurone), or N,N-dimethyl-N′-(3,4-dichlorophenyl) urea (diurone), 2,4-bis(N′,N′-dimethylureido)toluene or 1,4-bis(N′,N′-dimethylureido)benzene. The use of these compounds is described e.g. in the above mentioned U.S. Pat. No. 4,283,520. Suited accelerators are e.g. also the urea derivatives described in the GB 1,192,790.

Other suited accelerators are imidazoles, such as imidazole, 2-ethylimidazole, 2-phenylimidazole, 1-methylimidazole, 1-cyanoethyl-2-ethyl-4-methylimidazole or 2-ethyl-4-methylimidazole.

Further suited accelerators are also tertiary amines, their salts or quaternary ammonium compounds, such as benzyldimethylamine, 2,4,6-tris(dimethylaminomethyl)phenol, 4-aminopyridine, tripentylammoniumphenolate, tetramethylammoniumchloride or benzyltributylammoniumbromide or -chloride; or alkali metal alcoholates, such as sodium alcoholates of 2,4-dihydroxy-3-hydroxymethylpentane.

Other suited accelerators are the solid solutions of a nitrogen base and of a phenolic/aldehyde resin, as described in EP-A-200678, and the Mannich bases of polymer phenols, as described in EP-A-351365.

Preferred accelerators are chlorotolurone, imidazoles and urea derivatives.

Particularly preferred is chlorotolurone.

### Thermoplastic Powder

The thermoplastic powder is optionally used and is contained in the bonding agent in a concentration of 0 to 7 weight percent, preferably in a concentration of 0.5 to 3 weight percent, and more preferably in a concentration of 1 to 2 weight percent.

Furthermore, a thermoplastic powder, preferably an amorphous thermoplastic powder with a melting point below the melting point of the plastic component to be injected, can be used as ingredient of the bonding agent, as filler and/or as impact strength modifier. As thermoplastic powder, homopolymers and/or copolymers, including polypropylenes, polyamides, polyamide alloys, polyethylenes (of high or low density) (PE), polyphenylene oxide, PBT or PS can be used. LD-PE is preferred. The mean particle size d50 of the powder is not larger than 50 μm, and preferably smaller than 30 μm.

### Solvent

The solvent is optionally used and is contained in the bonding agent in a concentration of 0 to 66 weight percent, more preferably 40 to 60 weight percent.

As solvent, polar or nonpolar solvents can be used. In particular, a solvent OR, wherein R is H, alkyl or aryl, or a solvent N(R₁)(R₂) can be used, wherein R₁═H, R₂═H; R₁═H, R₂=alkyl; R₁═H, R₂=aryl; R₁═R₂=alkyl; and/or R₁═R₂=aryl. Alkyl in R, R₁ and R₂ contains 1 to 12 carbon atoms, preferably 1 to 6 carbon atoms. The solvent is preferably a reactive solvent and improves bonding to the metal substrate.

Furthermore, the bonding agent can contain halogenated or halogen-free flame retardants. Furthermore, colorants can be added.

Preferred compositions of the bonding agent are indicated in the following Table 1. The bonding agent according to the invention can contain one or more of the ingredients listed in Table 1 in the given concentration. Particularly preferred, the bonding agent contains all listed ingredients in the given concentrations.

TABLE 1
Preferred compositions of the bonding agent

| | Concentration | |
|---|---|---|
| | | Particularly |
| Composition of the bonding agent | Preferred | preferred |
| Epoxide (e.g. bisphenol A, bisphenol F, a | 20-80% | |
| novolac system or a combination of the same) | | |
| Hardener | 1-15% | 2-4% |
| Butanedioldiglycidether | 2-15% | |
| Diene copolymers and/or polyurethane based | 5-40% | 7-15% |
| on phenol | | |
| and/or polyurea or a combination of the same | | |
| Amino-terminal butadiene acrylonitrile | 1-15% | 4-8% |
| Carboxyl terminal butadiene acrylonitrile | 1-15% | 4-8% |
| Dicyandiamide | 1-15% | 5-11% |
| Chlorotolurone | 0-8% | 2-4% |
| Thermoplastic powder | 0-7% | 0.5-3% |
| Solvent (polar or nonpolar) | 0-66% | |
| Flame retardant (halogenated and/or | 0-30% | |
| halogen-free) | | |
| Colorant | 0-3% | |

The connection of metal and plastics for the manufacture of metal/plastic structural parts is performed by applying the plastics by injection molding to the metal component coated with the pre-crosslinked bonding agent.

The metal component can be coated with the bonding agent system before or after the shaping of the metal component. Typically, the shaping of the metal component is made by stamping and deep-drawing metal sheets. Possible coating methods are the so-called “coil coating” (coating before shaping), spray painting, immersion coating, powder coating (coating after shaping). Brush application is also possible. Alternatively, the coating methods can be employed in combination.

As solvents, the above defined solvents can be used in the coating method. The solvent adjusts the viscosity of the solution for the respective coating method and as reactive solvent reduces the curing time. Furthermore, by the functionality a higher degree of crosslinkage is achieved. By the formation of polar groups with the substrate, the separation force is increased.

If the bonding agent system is applied before the stamping and deep-drawing of the sheet metals in the coil coating method, the stamped and deep-drawn metal parts are not covered with bonding agent at their edges of cut. Possibly, they are neither coated with bonding agent in areas where they have been largely deformed.

To secure corrosion resistance, it is therefore necessary to either provide the metal areas without bonding agent subsequently with a bonding agent, or else to inject plastic material such that the uncovered areas are covered with plastic material, wherein the plastic material is glued with bonding agent around the complete periphery of the uncovered areas. Coil coating can be performed at a site spatially separated from stamping and deep-drawing. The sheet metals coated in the coil coating method are subsequently heated for such a period and at such a temperature that a dry and solid structure of the bonding agent system is achieved. The bonding agent system has to be partially crosslinked to such a degree that a dry surface is formed which is sufficiently resistant against handling damages. Then, the sheet metals are cut to size and shaped or stamped and shaped in the deep-drawing method. Subsequently, the sheet metals are degreased, and then the plastic component can be applied in a suited injection mold. Possibly, yet unprotected metal areas can then be provided with corrosion protection by painting etc.

In modification of the above method, a deep-drawing foil can be used for stamping and deep-drawing the sheet metals. The deep-drawing foil can be mounted after the coil coating (after the pre-crosslinking of the bonding agent system), or directly before the stamping and deep-drawing of the sheet metals. After stamping and deep-drawing of the sheet metals, the deep-drawing foil is removed. In this case, it is not necessary to degrease the sheet metals. Then, the plastic component is applied in a suited mold. Here, it can also be necessary to subsequently provide edges of cut or other exposed metal areas with corrosion protection, for example by a special painting, in case of parts liable to corrosion.

If the bonding agent system is applied after the shaping of the metal component, for example by spray painting, immersion coating, powder coating or catalytic immersion coating, the corrosion protection of the bonding agent system can be better utilized. Then, there are no unprotected edges of cut or damages of the bonding agent layer by the forming process. The corrosion resistance of the bonding agent system is then not only utilized in the area of the connection of the plastic component, but also in the areas not in contact with the plastic component. Thereby, the additional processing step of painting the metal component can be omitted. Moreover, areas which should not be covered with the bonding agent system can be purposefully left open if desired.

The adhesion of the bonding agent system on the metal can be improved by a suited pretreatment of the metal surface, for example by degreasing and/or cleaning; by a mechanical treatment, such as by abrasive blasting or brushing; by passivating; by electrical or physical activation.

To improve the adhesive strength of the surface of the metal, a drying process can be performed for 10 to 180 minutes at ambient temperature up to 150° C., preferably at least 20 minutes at 110° C. During this drying process, the solvent used for the coating is evaporated and a first step of crosslinking is started. Here, a hardener, preferably of the amine type, can be used. It is the hardener's job to permit an addition reaction for the polymerization of the epoxide. Furthermore, the adhesive strength of the adhesive layer/coating is reduced to ensure stability for handling. Moreover, a strong bond to the substrate (e.g. metal) is formed. This bond is strong enough to prevent a washing out by molding around the parts (e.g. injection molding). Furthermore, an anticorrosive layer is temporarily formed. Polymerization can take place with the polar groups e.g. of the solvent or by ring-opening with the connection of e.g. a diepoxide and a diamine.

After coating with the bonding agent system, it can be advantageous to after-treat the bonding agent coating, for example by letting drip, by drying or by a washing process. Subsequently, the binding of the bonding agent is effected, i.e. its partial crosslinking until it comprises handling strength. The required temperature and period depend on the used bonding agent system, for example 100° C. for 30 seconds or 140° C. for 40 seconds, or 120° C. for 20 seconds. In general, temperatures of between 80 and 160° C. and periods of between 10 seconds and 1 minute are appropriate.

Depending on the precuring method (microwave, induction furnace or hot-air furnace, in particular hot-air furnace), the duration of precuring is 20 seconds to 40 minutes. The metal coated with the bonding agent can now be cooled down to ambient temperature for storage or further processed in the heated state. At this stage, the coating already provides corrosion protection.

The metal component coated with the pre-crosslinked bonding agent system is now introduced into a suited mold. The design of the mold is adapted on the one hand to the design of the metal component, and on the other hand to the desired design of the plastic component, and the metal component is placed into the mold such that the bonding agent layer faces a free volume in the mold. The mold can be designed, for example, such that the plastic reinforcement structures are injected to the metal component. It is advantageous to preheat the mold to a defined temperature that depends on the bonding agent system. Pre-heating supports the heat-reactive behavior of the bonding agent system. Alternatively or additionally, the metal component can be preheated to the activation temperature of the bonding agent system. Such a pre-heating can be performed, for example, externally by induction heating, IR radiator, in a furnace, etc., or within the mold (during or after the introduction of the metal component into the mold), e.g. by IR radiators. Then, the plastic component starting material is injected. The high temperature of the liquid melt causes thermal activation, and as a rule the complete reaction of the bonding agent system. The plastics is permanently connected to the metal component. Subsequently, the generated hybrid structural part and the mold are preferably cooled so that they cool down more quickly, and the finished hybrid structural part is removed from the mold.

If a bonding agent system with a high activation temperature is used, it can be reasonable to let injection molding be followed by a tempering operation of the structural part to ensure complete curing of the bonding agent system and thus a reliable and stable connection of the plastic component to the metal component. This also applies to those areas coated with the bonding agent system to which no plastics was injected, so that corrosion protection is reliably ensured by the bonding agent system.

In a preferred embodiment, by the use of dicyandiamide in connection with polar groups of the solvent, a clamping seat of the plastic component, such as PA, to be applied by injection molding is achieved. Curing with dicyandiamide is preferably performed at 150° C.

Generally, the bonding agent system can be provided over the whole surface or only in some areas, moreover only on one side or on both sides on the surfaces of the metal component. One particular advantage of the bonding agent system according to the invention is that if the plastic component is connected to the metal component only on one side, a secure, loadable and permanent connection is achieved. The connection is a mere material connection, and additional protections by a positive connection of metal and plastics are not necessary. Of course, such positive connections can be additionally provided if they are not troublesome in the corresponding part, for example by injecting plastic material through openings of the metal component.

As for the connection of metal and plastics a one-sided material connection by means of a bonding agent system is sufficient, the surface of the metal component that is free from plastics is by no means deteriorated as to its appearance. This surface of the metal component can therefore be utilized as visible, for example decorative surface with a metal or lacquer appearance. In the processing of such a structural part with visible metal surface, this visible metal surface can (with the back side of the metal component being in each case treated with a bonding agent) be in different stages of processing. It can be, for example, brushed, presspolished, polished, lacquered with scratchproof transparent lacquer or with nano lacquer; it can be finished with coating lacquer; or it can be treated with a primer coat. In this case, the finished structural part is finally lacquered with the coating lacquer. Thus, the protection of the edges of cut is also achieved. To protect the visible metal surface in processing, for example during injection molding, it makes sense to cover the visible metal surface with a protective film. The protective film is not removed before injection molding.

Apart from the possibility of creating an optically non-impaired visible metal surface, the hybrid structural parts according to the invention offer numerous further advantages: they are statically and dynamically loadable; force or torque can be applied to them; they are failure-proof over the whole service life of the structural part; they are suited for security-relevant parts; they have a low weight but high flexural strength and torsion-stiffness; they are well protected from corrosion; and they are also suited for movable parts.

The hybrid structural parts according to the invention are used, for example, in the construction of vehicles; moreover in aircraft construction, in space engineering and in submarines, as housing of small motor apparatuses, to only mention a few.

The invention in particular relates to vehicle body parts for vehicle bodies comprising a hybrid structural part according to the invention. It should be noted that individual features of those illustrated below with respect to the vehicle body part, which in particular relate to the construction of the vehicle body part and the corresponding structural part, are considered as inventive alone and in particular without the features of claim 1 or of claim 8, or only with a part of these features. In structural parts and in particular vehicle body parts, the weight plays a considerable role. On the other hand, the loads to be taken up by the part are considerable, and considerable demands are in particular also made on the durability of the parts. Thus, despite the above illustrated prior art, in the body construction of vehicles and in particular in passenger cars, the conventional double-shell sheet metal construction is practically exclusively employed. This construction has proved to be inexpensive, stable and reliable over the years and is still being employed despite its disadvantageous weight. With the structural part according to the invention, the prerequisite for a vehicle body part is created which is, with respect to costs and reliability, comparable to vehicle body parts of double-shell sheet metal construction, which, however, on the other hand permits a considerable reduction of weight.

The vehicle body part can be a structural part according to the present invention or comprise a structural part manufactured according to the present invention, which represents a hybrid supporting structure for the vehicle body part.

The vehicle body part or the structural part can be designed according to the conventional construction, where lacquered sheet metal is provided at the visible surface. However, it is cheaper to deviate from this conventional construction and not to provide the metal component or the sheet metal at the surface of the visible side. Then, it is possible to construct the corresponding component such that the metal component is only present where it is required for stability reasons. In this manner, weight can be further reduced.

A covering element can be connected to the hybrid supporting structure. The covering element can be made of plastic material, in particular by injection molding. The covering element can be subsequently lacquered, for example by passing the vehicle body part with the rest of the vehicle body through the usual lacquering processes; a correspondingly colored plastic material can also be used.

The covering element can also be a structural part with a visible metal surface. As in such a structural part with visible metal surface, the metal component mainly serves optical purposes, the corresponding metal material can have a relatively thin design, so that corresponding vehicle body parts which optically practically do not differ from the conventional vehicle body parts, nevertheless permit weight reduction. In general, the hybrid supporting structure in the vehicle body part can be provided internally, that means invisibly or only partially visibly. It is in particular possible to provide coverings on both sides. With such an internal mounting of the hybrid supporting structure, injections through the sheet metal part are in particular in the visible areas possible. The metal component or the sheet metal part of the hybrid supporting structure, respectively, can also be designed as visible component. Stiffening by plastics applied by injection molding are then only possible on the side opposite the visible side, or only in covered areas, where injections, too, are only possible in the covered areas. Here, the sheet metal can be arranged on the outer surface, and the inner surface can be covered. The sheet metal can also be arranged on the inner surface and the outer surface can be covered. The corresponding sheet metals can be lacquered before the plastic injection process, or they can be lacquered after the plastic injection process. If they are lacquered before the plastic injection process, it can be advantageous to apply a protective film which is removed again after the application of the plastics by injection molding or after the assembly of the vehicle body part.

Seats for attachments can be formed in the plastic component of the structural part. Here, the seats in the hybrid supporting structure and/or a covering element can be provided. It is particularly advantageous to embody the seats such that corresponding attachments are firmly mounted after the connection of covering elements with the hybrid supporting structure, without any additional mounting being required. For this, it can be in particular advantageous to provide contact elements which exert, by a suited embodiment by recesses and/or weakening areas, a pretension on the attachment in the mounted state, so that the same is clamped in the mounted state.

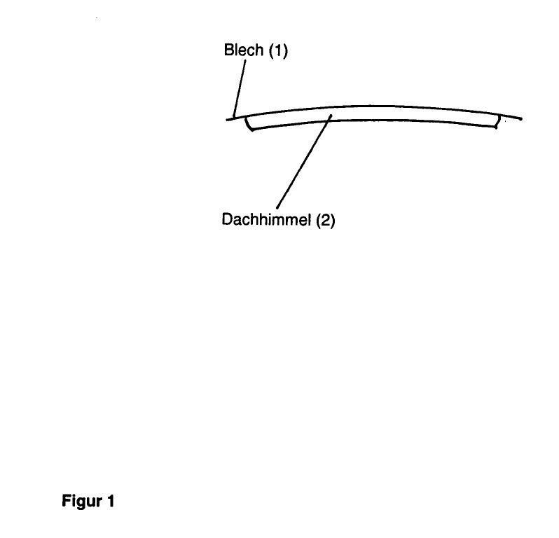

FIG. 1: plan view of a structural part according to the invention

FIG. 1 shows a sheet metal (1) to which a roof liner (2) in the form of a plastic component is injected.

What is claim is:

1. A method for the manufacture of a structural part comprising a metal component and a plastic component, comprising the following steps:
(a) providing the metal component, wherein the metal component is coated with a precured bonding agent system on at least one side;
(b) introducing the metal component coated with the precured bonding agent system into an injection mold, such that the precured bonding agent layer faces a free volume in the mold, and
(c) injection molding the plastic component onto the metal component, wherein the bonding agent system further cures,
wherein the bonding agent system comprises a plastic bonding agent or a plastic bonding agent in combination with a primer, wherein the plastic bonding agent is selected from an epoxide, a polyurethane, or a polyester, wherein the plastic bonding agent is modified with a diene, a polyene or a combination thereof, and wherein the bonding agent system is completely cross-linked by thermal activation in two steps.

2. The method of claim 1, further comprising coating the metal component with the bonding agent system before step (a) by spray painting, immersion coating, powder coating, catalytic immersion coating, or coil coating.

3. The method of claim 1, wherein the bonding agent system is precured before step (a) at a temperature of 100 to 140° C. for a duration of 20 to 40 seconds.

4. The method of claim 1, wherein the mold is preheated to a predetermined temperature before step (b).

5. The method of claim 1, wherein in step (c) complete curing of the bonding agent system is effected.

6. The method of claim 1, wherein the structural part is tempered after step (c) to completely cure the bonding agent system.

7. The method of claim 1, wherein the plastic component is injection molded in the form of a coating.

8. The method of claim 1, wherein the plastic component is injection molded in the form of stiffening structures.

9. The method of claim 1, wherein the metal component is preheated to a predetermined temperature before step (c).

10. The method of claim 1, wherein the metal component is coated on all sides with the precured bonding agent system.

11. The method of claim 1, wherein the plastic bonding agent is an epoxide, wherein the epoxide is an epoxy resin based on one or more of bisphenol A, bisphenol B, bisphenol C and bisphenol F.

12. The method of claim 1, wherein the plastic bonding agent is an epoxide, wherein the epoxide is an epoxy resin based on bisphenol A-diglycidyl ether or epoxy cresol novolac.

13. The method of claim 1, wherein the bonding agent system is modified by a covalent bond of the diene.

14. The method of claim 1, wherein the bonding agent system is modified by physically incorporating the diene, the polyene or a combination of diene and polyene into the bonding agent system.

15. The method of claim 14, wherein the proportion of the diene, the polyene, or the combination of diene and polyene in the bonding agent system is 1 to 30 weight percent.

16. The method of claim 1, wherein the bonding agent system is modified by an alkyl-modified silane, an aryl-modified silane, or a combination thereof of the general formula HO—Si(R)(R′)(R″), wherein the groups R, R′ and R″ are either the same or partially or all differently modified with alkyl groups, aryl groups, or a combination thereof, wherein one or more of the alkyl and aryl groups bears a functional group.

17. The method of claim 1, wherein the bonding agent system comprises a solvent OR, wherein R is H, alkyl or aryl, or a solvent N(R₁)(R₂), wherein R₁═H, R₂═H; R₁═H, R₂=alkyl; R₁═H, R₂=aryl; R₁═R₂=alkyl; or R₁═R₂=aryl

18. The method of claim 1, wherein the plastic component comprises a plastic material selected from polypropylene, polyamide, polyamide-polyphenylene oxide blends, polyamide-polystyrene blends, polyphthalamide, polypropylen sulfide and polysulfone.

19. Structural part, comprising a metal component, a plastic component injected to the metal component and a bonding agent system connecting the metal component and the plastic component, characterized in that the bonding agent system comprises a plastic bonding agent or a plastic bonding agent in combination with a primer, wherein the plastic bonding agent is a polyester, a polyurethane, or an epoxide, wherein the plastic bonding agent is modified with a diene, a polyene or a combination thereof, wherein the bonding agent system is completely cross-linked by thermal activation in two steps.
